(19) United States
(12) Patent Application Publication
(10) Pub. No.: US 2017/0262390 A1
(43) Pub. Date: Sep. 14, 2017

(54) DEVICE, PRIORITIZING PROCESS METHOD AND COMPUTER-READABLE RECORDING MEDIUM

(71) Applicant: FUJITSU LIMITED, Kawasaki-shi (JP)

(72) Inventor: Masaaki Noro, Kawasaki (JP)

(73) Assignee: FUJITSU LIMITED, Kawasaki-shi (JP)

(21) Appl. No.: 15/425,087

(22) Filed: Feb. 6, 2017

(30) Foreign Application Priority Data
Mar. 10, 2016 (JP) 2016-047601

(51) Int. Cl. G06F 13/18

(52) U.S. Cl. CPC G06F 13/18

(57) ABSTRACT

A device includes a memory and a processor coupled to the memory. The processor configured to determine types of applications which are to be executed by the processor. The processor configured to create priority information representing a priority of each of the applications, based on the determined types of applications. The processor configured to perform a process that relates to the applications according to an order based on the priority information created by the processor.

### CROSS-REFERENCE TO RELATED APPLICATION

This application is based upon and claims the benefit of priority of the prior Japanese Patent Application No. 2016-047601, filed on Mar. 10, 2016, the entire contents of which are incorporated herein by reference.

### FIELD

The embodiments discussed herein are directed to a smart device, a prioritizing process method, and a computer-readable recording medium.

### BACKGROUND

The period of the idle mode of a smart device, such as a smartphone or a smart watch, is longer than the time during which the smart device runs. For example, a smartwatch runs in limited occasions, for example, when the smartwatch is notified of an event by a smartphone or when the user changes the setting, and is in the idle mode in the remaining period. FIG. 9 is a diagram for explaining operations of a smartwatch.

As illustrated in FIG. 9, for example, when a smartwatch 8 in a BLE (Bluetooth (trademark) low energy) standby idle mode receives an event from a smartphone 9, the smartwatch 8 notifies a user of the event by using, for example, vibration or LED light. The smartwatch 8 performs an operation of, for example, transferring the e-mail message according to an operation of the user and then returns to the idle mode.

As described above, the period of the idle mode of a smart device is long and therefore reducing the power consumption during the idle mode enables extension of the running time of the buttery. For this reason, there is a technology for causing transition of the mode of a smart device from the idle mode to the hibernation mode. FIG. 10 is a diagram for explaining reduction of the power consumption by using hibernation.

As illustrated in FIG. 10, while the power consumption increases when a smart device is in an active mode, the period of the active mode is shorter than the period of the idle mode. For this reason, lowering the power consumption in the idle mode by using hibernation enables reduction of the power consumption of the smart device. In FIG. 10, “idle mode power (old)” represents the power consumption in the idle mode in a case where hibernation is not performed and “idle mode power (new)” represents the power consumption in the idle mode in a case where hibernation is performed.

In order to cause transition of the mode of the smart device to the hibernation mode, it is needed to save the data of the central processing unit (CPU) and the memory and to restore the saved data when the smart device enters the active mode. FIG. 11 is a diagram for explaining saving and restoring of data on transition of the mode.

As illustrated in FIG. 11, the smartwatch 8 performs data saving process before transitioning from the active mode to the hibernation mode and, when recovering from the hibernation mode, performs a data recovering process before recovering from the hibernation mode. For this reason, in hibernation, it is important to shorten the time to save data and the time to restore data as much as possible.

There is a technology in which a pre-active mode is provided to a smart device to shorten the restoration process on recovery from the hibernation mode. FIG. 12 is a diagram for explaining the pre-active mode. As illustrated in FIG. 12, the smartwatch 8 transitions to the pre-active mode before transitioning from the hibernation mode to the active mode and then transitions from the pre-active mode to the active mode.

In the restoration process, the smartwatch 8 controls the volume of data to be restored until the user processing is restarted. In the pre-active mode, the smartwatch 8 restores the remaining data in the background while restarting the user processing. Thus, the smartwatch 8 is able to shorten the time to the restart of the user processing.

When the user processing is restarted in the pre-active mode, however, many processes are restarted at the same time and thus the load increases and the performance of the smartwatch 8 lowers and accordingly responses to user operations worsen. There is a technology of restoring a memory area that is used by applications sequentially and starting the applications by using a started app table that defies an order in which the applications are started.

There is another technology that enables transition to a running mode with high responsiveness by causing transition of the computing environment to a low-power-consuming connected-standby mode and limiting functions other than desired functions.

Patent Document 1: Japanese Laid-open Patent Publication No. 10-293619

Patent Document 2: Japanese National Publication of International Patent Application No. 2014-522061

In order to restore a memory area that is used by applications sequentially and start the applications by using a started app table, it is needed to define the start app table. A device that is able to add and delete applications, however, is not able to in advance prioritize applications with respect to, for example, a process of, for example, start-up and thus is not able to perform a process that is performed according to the priority. This results in a problem that, in the device that is able to add and delete applications, many processes area performed at the same time and thus the load of the smart device increases in the pre-active mode.

### SUMMARY

According to an aspect of an embodiment, a device includes a memory and a processor coupled to the memory. The processor configured to determine types of applications which are to be executed by the processor. The processor configured to create priority information representing a priority of each of the applications, based on the determined types of applications. The processor configured to perform a process that relates to the applications according to an order based on the priority information created by the processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of a functional configuration of a smart device according to a first embodiment;

FIG. 2 is a diagram of an exemplary app priority table;

FIG. 3 is a flowchart of a flow of a process performed by a priority determination unit;

FIG. 4 is a flowchart of a flow of a process performed by an app manager;

FIG. 5 is a diagram for explaining data restoration in a pre-active mode;

FIG. 6 is a diagram of a functional configuration of a smart device according to a second embodiment;

FIG. 7 is a flowchart of a flow of a process performed by a swap manager;

FIG. 8 is a diagram of a hardware configuration of a computer that executes an app starting program according to the first embodiment;

FIG. 9 is a diagram for explaining operations of a smartwatch;

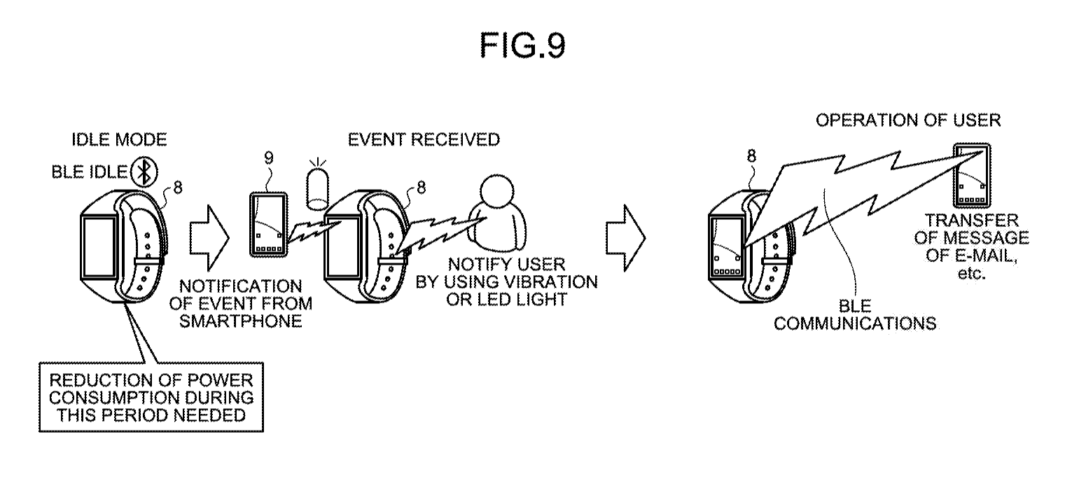

FIG. 10 is a diagram for explaining reduction of power consumption by using hibernation;

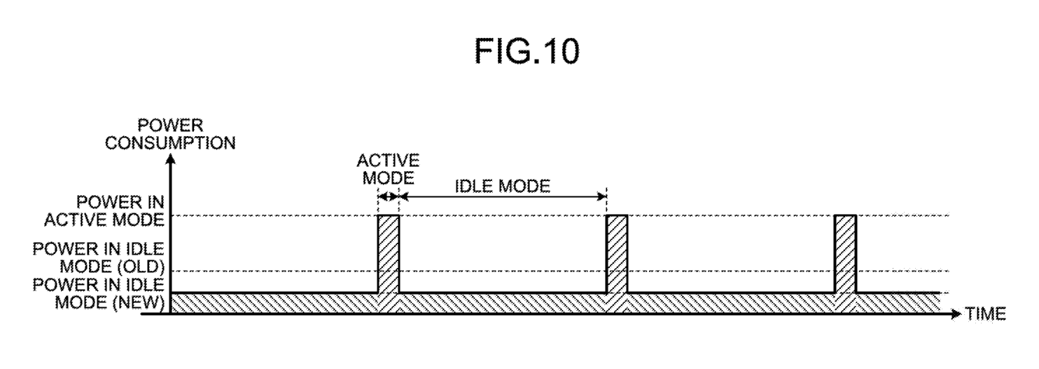

FIG. 11 is a diagram for explaining data saving and data restoration; and

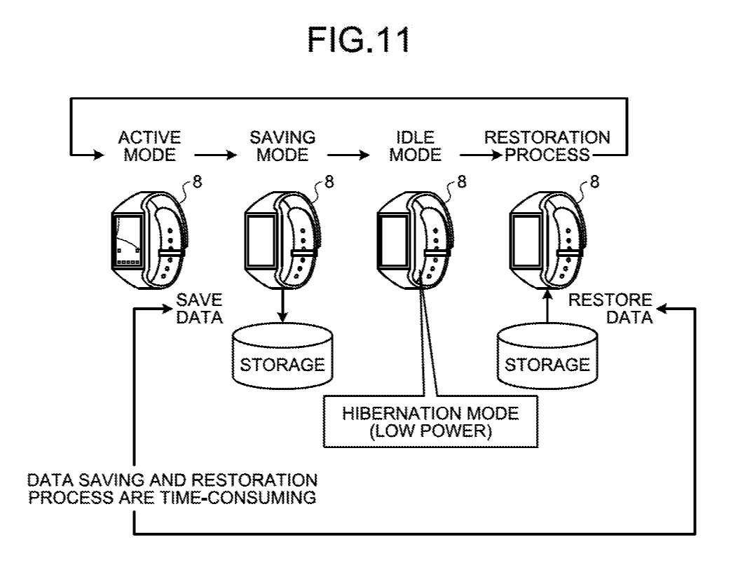

FIG. 12 is a diagram for explaining a pre-active mode.

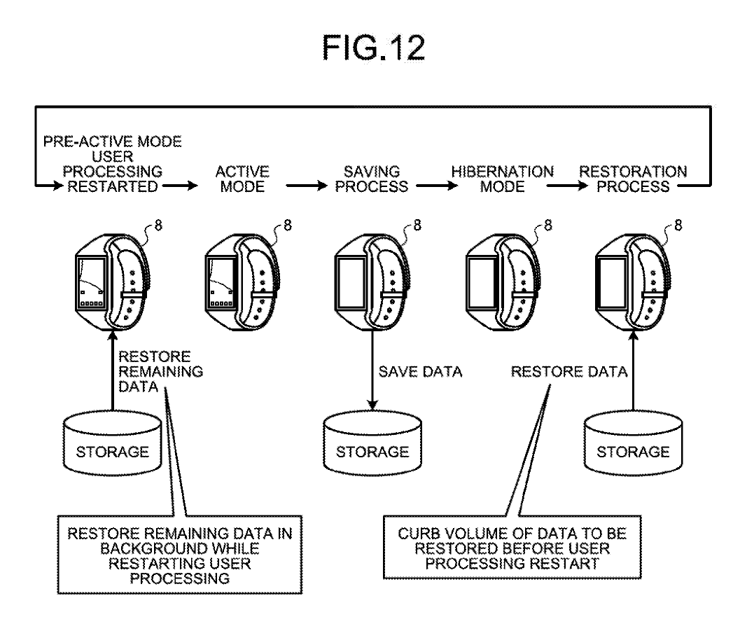

### DESCRIPTION OF EMBODIMENTS

Preferred embodiments of the present invention will be explained with reference to accompanying drawings. A case where the priority in starting applications is determined will be described as a first embodiment and a case where the priority in loading data of applications from a storage into a memory is determined will be described as a second embodiment. Hereinafter, “application” is commonly referred to as “app”. Note that the embodiments do not limit the technology disclosed herein.

### [a] First Embodiment

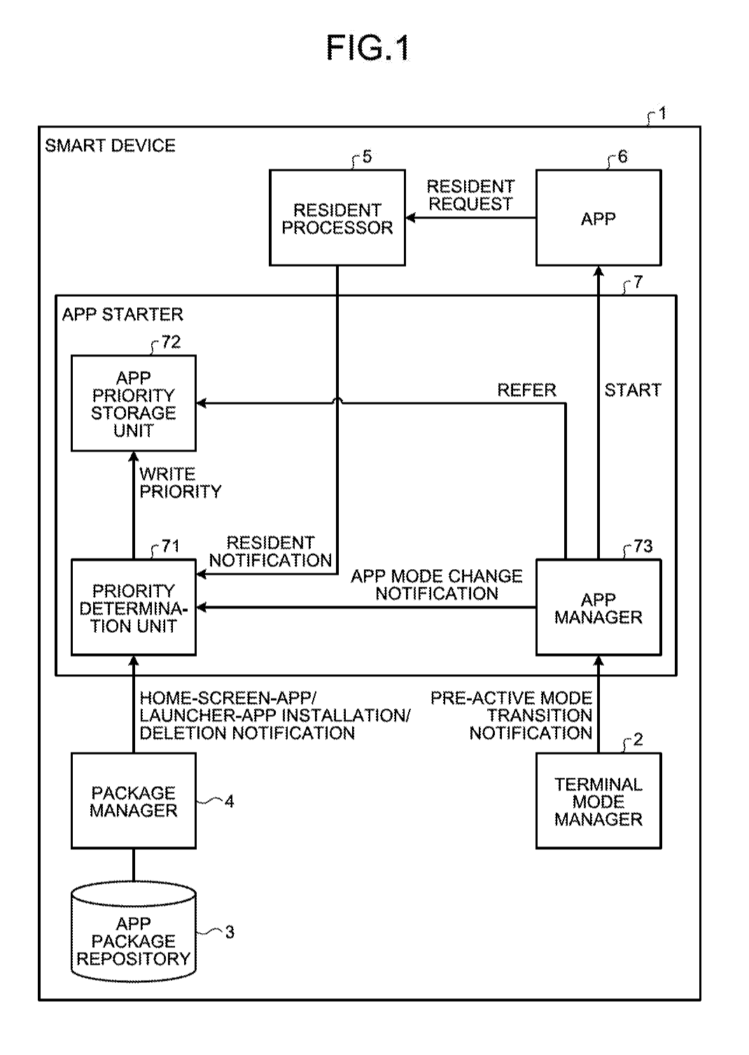

First of all, a functional configuration of a smart device according to the first embodiment will be described. FIG. 1 is a diagram of a functional configuration of the smart device according to the first embodiment. As illustrated in FIG. 1, a smart device 1 includes a terminal mode manager 2, an app package repository 3, a package manager 4, a resident processor 5, app 6, and an app starter 7.

The terminal mode manager 2 manages the mode of the smart device 1. The mode of the smart device 1 includes an active mode, a hibernation mode, and a pre-active mode. When the mode of the smart device 1 transitions to the active mode, the terminal mode manager 2 issues a transition-to-pre-active-mode notification to the app starter 7.

The app package repository 3 stores information on app packages. The package manager 4 manages app packages by using the app package repository 3. When a home screen app that displays a home screen or a launcher app is installed, the package manager 4 transmits an installation notification to the app starter 7 and, when the home screen app or the launcher app is deleted, transmits a deletion notification to the app starter 7.

On receiving a resident request from the app 6, the resident processor 5 designates the app 6 as a resident app and notifies the app starter 7 of the fact that the app 6 is designated as a resident app by issuing a resident notification. The app 6 is an application that runs on the smart device 1. Note that a resident app is an app that is resident in the memory and is constantly executed.

The app starter 7 determines the priority in starting the apps 6 according to the types of the apps 6 and controls starting of the apps 6 according to the determined priority. The app starter 7 includes a priority determination unit 71, an app priority storage unit 72, and an app manager 73.

The priority determination unit 71 determines the types of the apps 6, determines the priority in starting the apps 6, and writes the priority in the app priority storage unit 72. The app priority storage unit 72 stores an app priority table representing the priority in starting the apps.

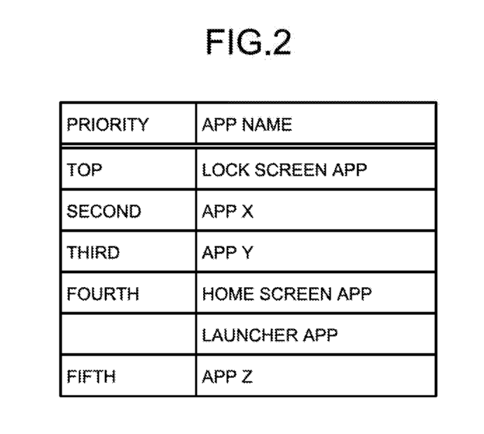

FIG. 2 is a diagram of an exemplary app priority table. As illustrated in FIG. 2, in the app priority table, the priority and app names are associated with each other. The priority represents the starting priority. The priority includes the top, the second, the third, the fourth and the fifth. The app names are names that specify the apps 6.

The app 6 that is the top priority is a lock screen app that is fixed. The lock screen app is the app 6 that displays a screen for unlocking. The app 6 that is the second priority is a foreground app. The foreground is a mode where the screen that is output by the app 6 is displayed on the display device. According to FIG. 2, the app X is the foreground app. The foreground app is identified by the app manager 73.

The app 6 with the third priority is a resident app. According to FIG. 2, the app Y is a resident app. A resident app is specified in a way that the resident processor 5 receives a resident request from the app 6. The app 6 that is the fourth priority is the home screen app and the launcher app that are fixed. The home screen app and the launcher app are identified by the package manager 4.

The app 6 with the fifth priority is another general app, i.e., a remaining app 6 after exclusion of the apps 6 with upper priority among the apps 6. According to FIG. 2, the app Z is a general app. The third priority, fourth priority and fifth priority may be assigned to multiple apps 6.

On receiving a notification indicating a change of the app mode from the app manager 73 as an event, the priority determination unit 71 determines the content of the mode change. When the foreground app changes, the priority determination unit 71 changes the priority of the app 6 that is switched to the foreground to the second and changes the priority of the app 6 that is switched from the foreground to the background to the fifth. The background is a mode where the screen that is output by the app 6 is not displayed on the display device.

When the app 6 ends and the app 6 having ended has the third priority, the priority determination unit 71 deletes the name of the app 6 having ended from the app priority table.

On receiving the resident-app notification as an event from the resident processor 5, the priority determination unit 71 changes the priority of the app 6 designated as a resident app to the third. On receiving a notification indicating installation of the home screen app or the launcher app as an event from the package manager 4, the priority determination unit 71 changes the priority of the home screen app or the launcher app to the fourth.

On receiving a home-screen-app/launcher-app deletion notification as an event from the package manager 4, the priority determination unit 71 deletes the home screen app or the launcher app from the app 6 with the fourth priority.

The app manager 73 manages the mode of the apps 6 and manages the entire application control. The app manager 73 starts and ends the apps 6, switches between their foreground and background, and notifies the priority determination unit 71 of the mode change of the apps 6. On receiving a notification indicating transition of the smart device 1 to the pre-active mode from the terminal mode manager 2, the app manager 73 refers to the app priority table and starts the apps 6 according to the priority.

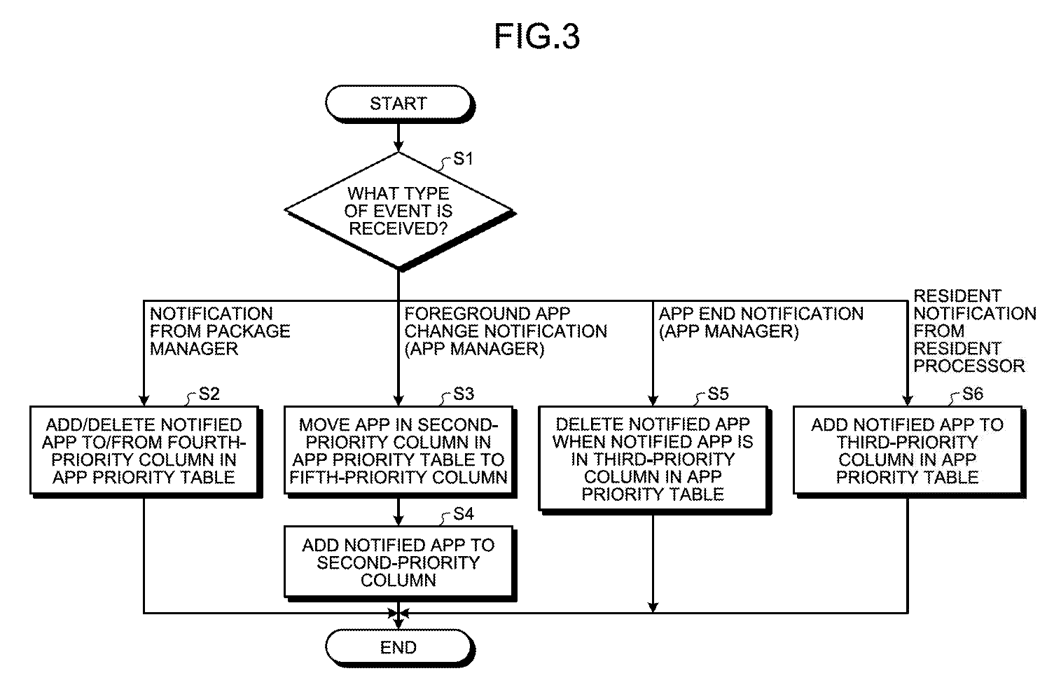

The flow of the process performed by the priority determination unit 71 will be described here. FIG. 3 is a flowchart of the flow of the process performed by the priority determination unit 71. As illustrated in FIG. 3, on receiving an event, the priority determination unit 71 determines the type of the received event (step S1).

As a result, when the type of the received event is an installation notification or a deletion notification from the package manager 4, the priority determination unit 71 adds/deletes the notified app 6 to/from the fourth-priority column in the app priority table (step S2).

When the type of the received event is a foreground app change notification from the app manager 73, the priority determination unit 71 moves the app 6 in the second-priority column in the app priority table to the fifth-priority column (step S3). The priority determination unit 71 adds the notified app 6 to the second-priority column in the app priority table (step S4).

When the received event type is an app end notification from the app manager 73, the priority determination unit 71 deletes the notified app 6 when the notified app 6 is on the third-priority column in the app priority table (step S5).

When the type of the received event is a resident-app notification from the resident processor 5, the priority determination unit 71 adds the notified app 6 to the third-priority column in the app priority table (step S6).

As described above, the priority determination unit 71 determines the type of a received event and updates the app priority table according to the type of the app 6 and accordingly, on its transition to the pre-active mode, the smart device 1 is able to start the apps 6 sequentially according to the app priority table.

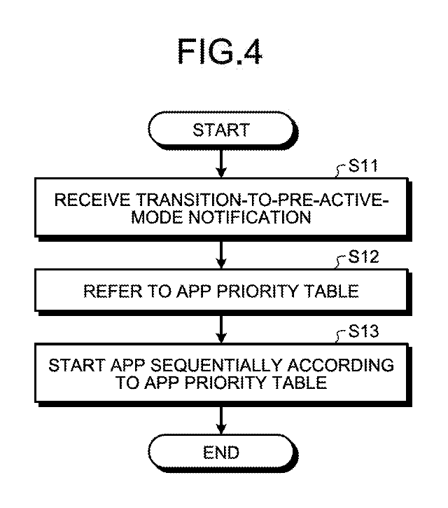

The flow of the process performed by the app manager 73 will be described here. FIG. 4 is a flowchart of the flow of the process performed by the app manager 73. As illustrated in FIG. 4, the app manager 73 receives a transition-to-pre-active-mode notification from the terminal mode manager 2 (step S11). The app manager 73 then refers to the app priority table (step S12) and sequentially starts the apps 6 according to the app priority table (step S13).

As described above, on receiving the transition-to-pre-active-mode notification, the app manager 73 sequentially starts the apps 6 according to the app priority table and thus is able to prevent the smart device 1 in the pre-active mode from being over-loaded.

As described above, in the first embodiment, the priority determination unit 71 determines the types of the apps 6, determines the priority in starting the apps 6, and then writes the priority in the app priority storage unit 72. When the smart device 1 transitions to the pre-active mode, the app manager 73 sequentially starts the apps 6 on the basis of the app priority storage unit 72.

Accordingly, the smart device 1 is able to prevent multiple processes from being started simultaneously in the pre-active mode and reduce the load. Thus, the smart device 1 is able to prevent deterioration of responses to user operations.

In the first embodiment, the app manager 73 starts the lock screen app at the highest priority. Accordingly, on its transition to the pre-active mode, the smart device 1 is able to display the lock screen quickly.

In the first embodiment, the app manager 73 starts the foreground app at the second highest priority. Thus, on unlocking, the smart device 1 is able to display the screen that is output by the app 6 that is operated by the user just before the transition to the hibernation mode on the display device quickly.

In the first embodiment, after starting the resident application following the foreground app, the app manager 73 starts the home screen app and the launcher app before starting the general app. Thus, when the user wants to switch the app 6 that is operated just before the transition to the hibernation mode to the different app 6, the smart device 1 enables a quick switch.

### [b] Second Embodiment

The case where the smart device 1 in the pre-active mode starts the apps 6 by using the app priority table has been described as the first embodiment. The app priority table may be also used to restore the data in the pre-active mode. The case where the app priority table is used to restore data in the pre-active mode will be described as the second embodiment.

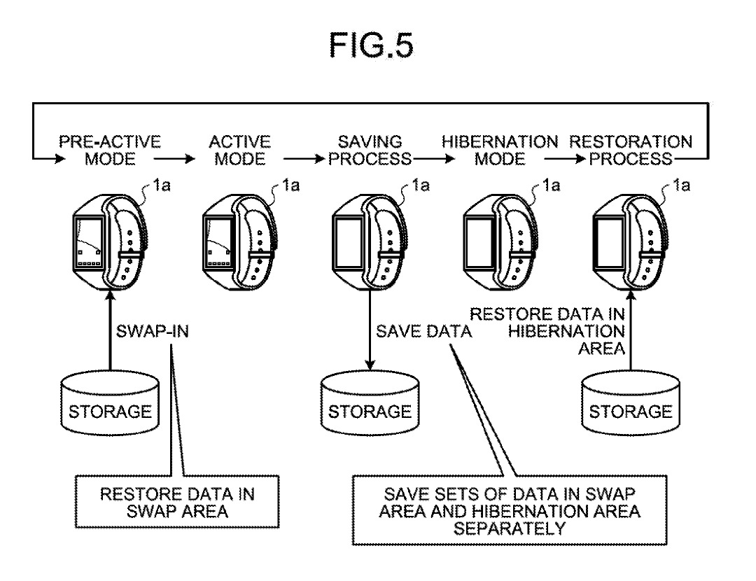

FIG. 5 is a diagram for explaining data restoration in the pre-active mode. FIG. 5 illustrates a smartwatch as an exemplary smart device 1a according to the second embodiment. As illustrated in FIG. 5, the smart device 1a saves sets of data separately in a swap area and a hibernation area in a saving process on its transition to the hibernation mode.

The data needed when the user processing is restarted, such as the data of the memory that is used by the kernel of the operating system (OS), is saved in the hibernation area and the data not needed when the user processing is restarted is saved in the swap area.

In a restoration process on the recovery from the hibernation mode, only the data in the hibernation area is restored. In the pre-active mode, the data in the swap area is restored and, when the restoration of the data in the swap area completes, the smart device 1a transitions to the active mode.

As described above, the smart device 1a saves the data unneeded when the user processing is restarted in the swap area and thus is able to save and restore data by using the swap function.

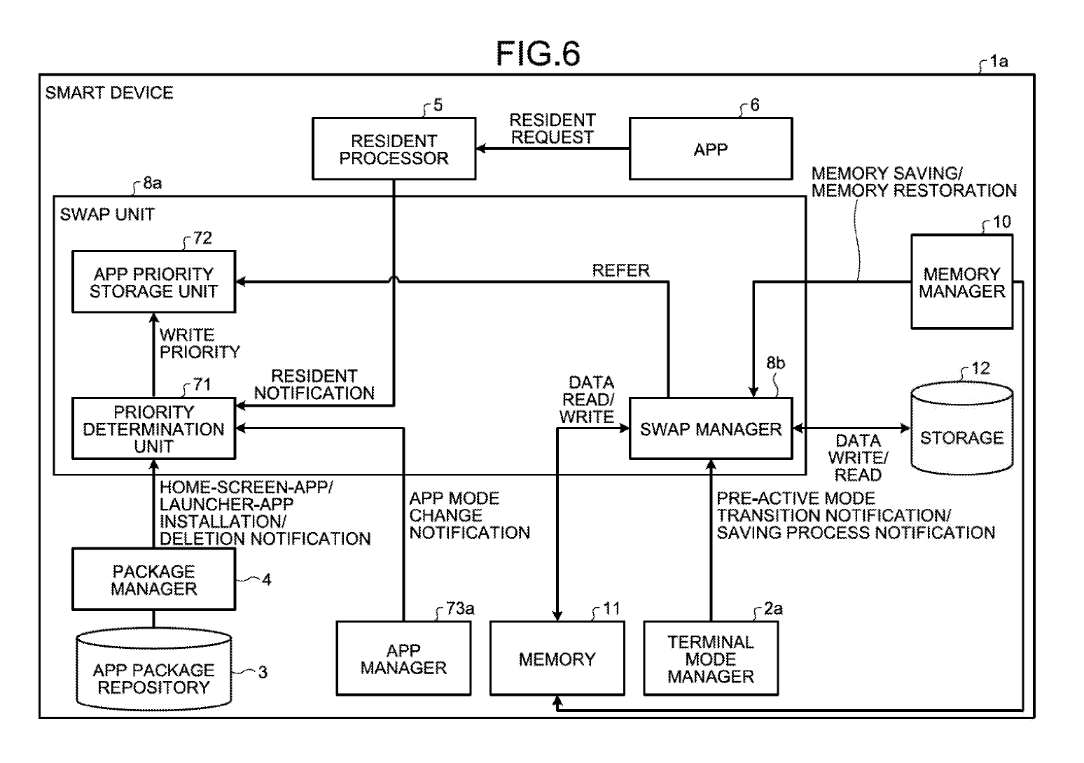

The functional configuration of the smart device 1a according to the second embodiment will be described here. FIG. 6 is a diagram of the functional configuration of the smart device 1a according to the second embodiment. For convenience of description, the functional units that play the same roles as those of the units illustrated in FIG. 1 are denoted with the same reference numbers as those in FIG. 1, and detailed descriptions thereof will be omitted below.

As illustrated in FIG. 6, differently from the smart device 1 illustrated in FIG. 1, the smart device 1a includes a terminal mode manager 2a instead of the terminal mode manager 2, includes a swap unit 8a instead of the app starter 7, and includes an app manager 73a instead of the app manager 73. The smart device 1a further includes a memory manager 10.

While the terminal mode manager 2a has the same function as that of the terminal mode manager 2, the terminal mode manager 2a transmits the transition-to-pre-active-mode notification and a saving process notification to the swap unit 8a. The swap unit 8a includes the priority determination unit 71, the app priority storage unit 72, and a swap manager 8b. The app priority storage unit 72 that stores the app priority table that is updated by the priority determination unit 71 is referred to by the swap manager 8b in the data restoration process.

The swap manager 8b manages saving, in a storage 12, the data of a memory 11 and restoration of the data from the storage 12. On receiving a saving instruction or a restoration instruction from the memory manager 10, the swap manager 8b saves the data of the memory 11 or restores, in the memory 11, the data.

On receiving a transition-to-pre-active-mode notification from the terminal mode manager 2a, the swap manager 8b refers to the app priority table and restores, in the memory 11, the data of the apps 6 from the storage 12 according to the order of the priority in the app priority table. On receiving a saving process notification from the terminal mode manager 2a, the swap manager 8b saves, in the storage 12, the data of the memory 11 that is used by the apps 6.

The memory manager 10 manages the memory 11 according to each memory block. When shortage of the memory 11 occurs, the memory manager 10 transmits a memory saving instruction to the swap manager 8b and, when data that is not in the memory 11 is needed, transmits a memory restoration instruction to the swap manager 8b.

The app manager 73a manages the mode of the apps 6 and manages the entire application control as the app manager 73 does and further transmits an app mode change notification to the priority determination unit 71 of the swap unit 8a.

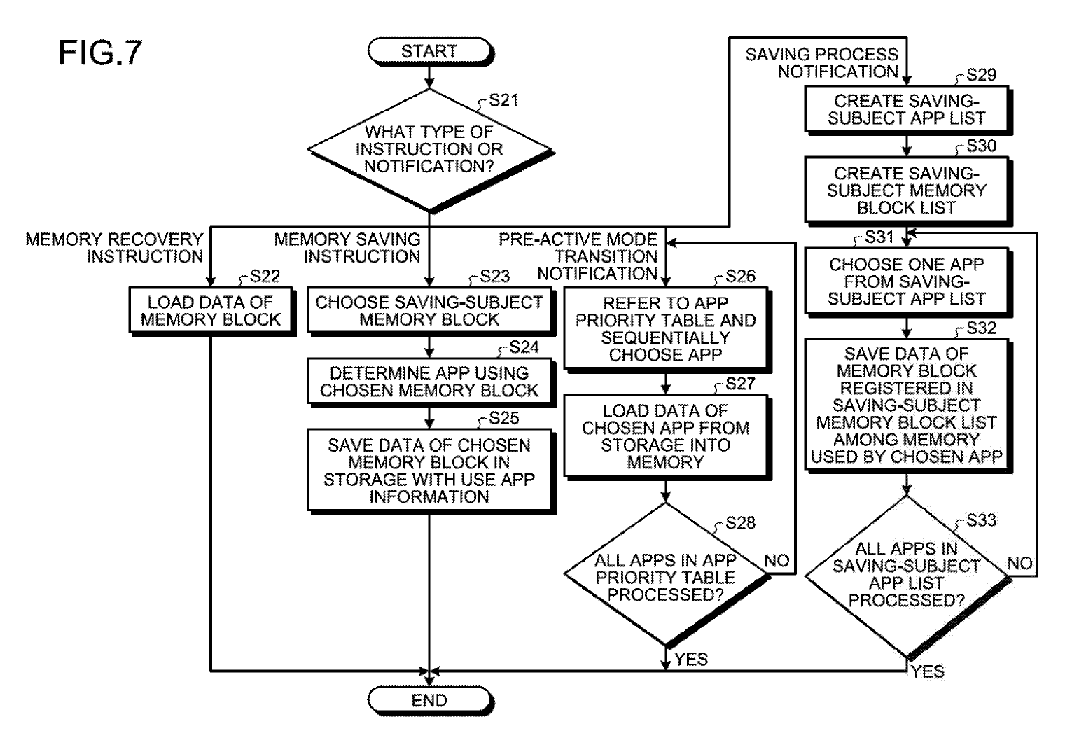

The flow of the process performed by the swap manager 8b will be described here. FIG. 7 is a flowchart of the flow of the process performed by the swap manager 8b. As illustrated in FIG. 7, the swap manager 8b determines what the content of an instruction or a notification is (step S21). When the content is a memory restoration instruction, the swap manager 8b loads the data of the memory block according to the instruction (step S22).

When the content is a memory saving instruction, the swap manager 8b chooses a saving-subject memory block (step S23) and determines the app 6 that uses the chosen memory block (step S24). The swap manager 8b then saves the data of the chosen memory block in the storage 12 in association with the use app information (step S25).

When the content is the transition-to-pre-active-mode notification, the swap manager 8b refers to the app priority table, chooses processing-subject app according to the order of the priority (step S26), and loads the data of the chosen app 6 from the storage 12 into the memory 11 (step S27).

The swap manager 8b then determines whether all the apps in the app priority table have been processed (step S28). When there is an app 6 that has not been processed, the swap manager 8b returns to step S26. When all the apps have been processed, the swap manager 8b ends the process.

When the content is a saving process notification, the swap manager 8b creates a saving-subject app list (step S29) and creates a saving-subject memory block list (step S30). The swap manager 8b then chooses one of the apps 6 from the saving-subject app list (step S31) and saves the data of the memory block that is registered in the saving-subject memory block list among the memory used by the chosen app 6 (step S32).

The swap manager 8b then determines whether all the apps in the saving-subject app list have been processed (step S33). When there is an app 6 not having been processed, the swap manager 8b returns to step S31. When all the apps have been processed, the swap manager 8b ends the process.

As described above, in the second embodiment, on receiving a transition-to-pre-active-mode notification, the swap manager 8b restores the data of the apps 6 according to the order of the priority in the app priority table. Accordingly, the smart device 1a is able to quickly display a screen that is highly likely to be operated by the user.

The app starter 7 according to the first embodiment is implemented by a computer by executing an app starting program with the same function as that of the app starter 7. The computer that executes the app starting programs will be described here. Similarly, the swap unit 8a of the second embodiment is implemented by using a swap program with the same function as that of the swap unit 8a, and the swap program is executed by the same computer.

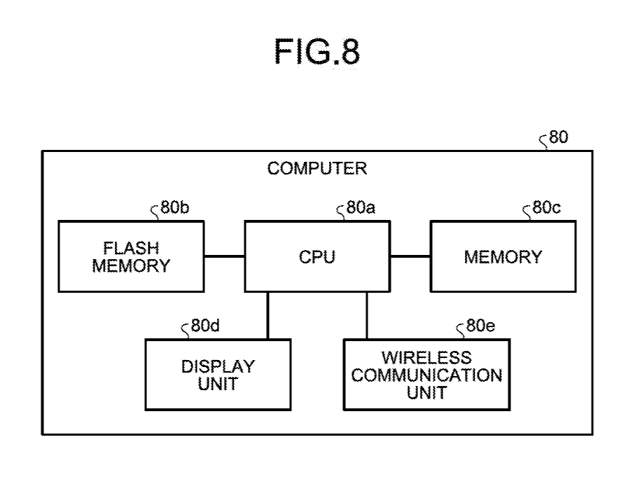

FIG. 8 is a diagram of a hardware configuration of a computer that executes the app starting program according to the first embodiment. As illustrated in FIG. 8, a computer 80 includes a CPU 80a, a flash memory 80b, a memory 80c, a display unit 80d, and a wireless communication unit 80e.

The CPU 80a is a processing device that reads and executes the app 6 that is stored in the memory 80c and a program, such as the app starting program. The flash memory 80b is a non-volatile memory that stores, for example, the app 6, the app starting program, and package information. The flash memory 80b corresponds to the storage 12 illustrated in FIG. 6.

The memory 80c is a random access memory (RAM) that stores, for example, the app 6 and the app starting program that are read from the flash memory 80b. The memory 80c stores, for example, the data needed to execute the app starting program and the intermediate result of execution of the app starting program. The memory 80c corresponds to the memory 11 illustrated in FIG. 6.

The display unit 80d is a device that displays a screen that is output by the app 6 and is, for example, a liquid crystal display device. The display unit 80d accepts a touch operation of the user and passes the accepted data to the CPU 80a.

The wireless communication unit 80e is a module that performs wireless communications, such as communications via a local area network (LAN), Bluetooth (trademark), and mobile phones. The wireless communication unit 80e may have multiple wireless communication functions.

The case where the app priority table is used to start the apps and app data loading has been described as the second embodiment; however, the present invention is not limited to this. For example, this also applied to the case where the app priority table is used for a process, such as app data saving.

According to an aspect of the embodiments, it is possible to curb the load of the smart device in the pre-active mode.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A device comprising:
a memory; and
a processor coupled to the memory and configured to:
determine types of applications which are to be executed by the processor;
create priority information representing a priority of each of the applications, based on the determined types of applications; and
perform a process that relates to the applications according to an order based on the priority information created by the processor.

2. The device according to claim 1, wherein, in a pre-active mode, the processor configured to perform the process to start the applications according to the order based on the priority information created by the processor.

3. The device according to claim 1, wherein, in a pre-active mode, the processor configured to perform the process to load data from a swap area of a storage into a memory according to the order based on the priority information created by the processor.

4. The device according to claim 1, wherein the processor configured to create the priority information on receiving any one of a notification on designation of an application as a resident application, a notification on a change of a mode of the application, a notification on any one of installation and deletion of any one of the application that displays a home screen and a launcher application.

5. The device according to claim 1, wherein the processor configured to create the priority information where an application that displays a lock screen is a top priority, a foreground application is a second priority, a resident application is a third priority, and any one of the application that displays a home screen and a launcher application is a fourth priority.

6. A prioritizing method for a computer to execute a process comprising:
determining, using a processor, types of applications and creating, using the processor, priority information representing a priority of each of the applications; and
performing, using the processor, a process that relates to the applications according to an order based on the priority information.

7. A non-transitory computer-readable recording medium that stores therein a program that causes a computer to execute a process comprising:
determining types of applications and creating priority information representing a priority of each of the applications; and
performing a process that relates to the applications according to an order based on the priority information.
